(19) United States
(12) Patent Application Publication
(10) Pub. No.: US 2005/0100344 A1
(43) Pub. Date: May 12, 2005

(54) System for coherent optical communication

(76) Inventor: Josh N. Hogan, Los Altos, CA (US)

Correspondence Address: JOSH HOGAN, 620 KINGSWOOD WAY, LOS ALTOS, CA, 94022, US

(21) Appl. No.: 10/701,902

(22) Filed: Nov. 6, 2003

(51) Int. Cl. H04B 10/04

(52) U.S. Cl. 398/183

(57) ABSTRACT

The invention teaches a coherent optical system using a set of wavelengths at the transmitter and receiver ends. In both homodyne and heterodyne coherent detection, the invention provides for the transmission of an additional modulated reference wavelength. The invention provides for matching a set of wavelengths at the detection and transmission ends of the optical system.

### FIELD OF INVENTION

This invention relates to optical systems, and more particularly to coherent optical systems. This application claims priority from a provisional of the same title filed Nov. 7, 2002.

### BACKGROUND OF THE INVENTION

Coherent optical fiber systems have the potential to greatly improve receiver sensitivity and selectivity. A disadvantage of coherent optical fiber systems is the necessity of acquiring the received carrier frequency to provide the correct local oscillator frequency for demodulating the received signal. Determining, creating and locking the local oscillator frequency is difficult and costly to implement. See U.S. Pat. No. 6,118,565.

F. J. Mendieta, M. Corona, and A. Arvizu, in paper entitled “Coherent Optical Communications Demonstration Experiment Using a Self-Heterodyne Interferometric Technique with Controlled-Spectral-Density Laser Fields, Instrumentation and Development Vol 3. Nr. 6/1996, illustrate a typical coherent optical fiber transmission system. While advantages are notable, various difficulties are associated with the optical transmitter, the communication channel, and the receiver. These difficulties must be solved. The authors opine that one of the most important difficulties is related to the phase noise and spectral instabilities that affect the optical fields in the coherent transmission that affect the optical fields in coherent transmission/reception processes. All these difficulties constitute limiting factors in the performance of angular modulation systems, particularly those employing multi-level format such as M phase shift key (M-PSK). Phase noise causes considerable spectral broadening and transposition to electrical intermediate frequency (IF) or to baseband after coherent detection results in a noisy reference for the demodulation and synchronization operations.

Another difficulty relates to long-term drift in the central optical frequency generated by the transmitter laser or the local oscillator. Drift control requires an optoelectronic automatic frequency control loop with a wide acquisition range. Homodyne systems require automatic control of the optical field's instantaneous phase.

Further difficulties arise from the depolarization of the optical field in standard telecommunications fibers, which requires a receiver structure with active polarization control or diversity detection. Further problems are related to the requirement of a minimum power for the laser local oscillator to reach the quantum limit, and the need of spatial synchronization in free space systems.

### SUMMARY OF THE INVENTION

The invention teaches a coherent optical system using a set of wavelengths at the transmitter and receiver ends. In both homodyne and heterodyne coherent detection, the invention provides for the transmission of an additional modulated reference wavelength. Further, the invention also provides a method of matching a set of wavelengths at the detection and transmission ends of the optical system. The system may also be used as a coherent analysis system.

The invention is described in terms of two sets of possible implementations (preferred embodiments):
(1) with no wavelength generation (Local Oscillator-LO) at detection end.
(2) with wavelength generation (LO) at the detection end and locking or matching the transmission and detection wavelength sets.

The invention includes a variation incorporating differential phase shift key (DPSK) detection. DPSK is a version of coherent detection that does not require local oscillation.

In PSK, information is encoded as one of two possible phase orientations therefore, a reference signal is needed to decode, but homodyne detection is difficult, owing to phase noise.

DPSK encodes information in the relative phase of successive bits of information, and can be decoded without a separate reference (i.e. by self-referencing).

Generating all wavelengths as a coherent set enables a simplification and an enhancement of DPSK.

Moreover, Polarization Mode Dispersion (PMD) compensation is also improved because, in the inventive system, a coherent set of wavelengths is generated.

### BRIEF DESCRIPTION OF THE DRAWINGS

FIG. 1 depicts optical communication
(a) coherent optical communication
(b) direct detection

FIGS. 2, 2A(a) and 2A(b) and 2B inclusive, depicts preferred embodiments of the invention.

FIG. 3 depicts a preferred embodiment.

FIG. 4 depicts the detection system for FIG. 2A(b) implementation.

FIG. 5 is for the illustration of the embodiment in FIG. 2B.

FIG. 6 illustrates beating of wavelengths.

FIG. 7 represents a self-referencing feature of DPSK.

FIG. 8 represents a coherent optical analysis system.

### DETAILED DESCRIPTION OF THE DRAWINGS

FIG. 1A depicts a typical optical communications, or, more accurately, optical detection, system. Components include the transmitter T, consisting of a laser diode (OSC 1) modulated at the transmitter side, that transmits optical pulses through a fiber F and to a detector/receiver (D/R). In coherent detection, the received optical signal is mixed by means of a coupler with a local oscillator (OSC 2) and the resultant signal is detected and the electronic signal processed.

There are two detection approaches: Heterodyne and homodyne.

In heterodyne detection, the frequency (wavelength) of the local oscillator (LO) is different from the transmitting center frequency (or center wavelength). The heterodyne approach is sensitive to the frequency (wavelength) offset between the two lasers. The offset needs to be kept constant. Keeping the offset constant can be difficult because the transmitting laser and the receiving laser drift independently. Fiber characteristics will also impact the signal as it is received by the receiving side. A very difficult challenge associated with the heterodyne approach is the continuous matching of the local oscillator with the wavelength of the transmitting oscillator.

Homodyne detection is more sensitive than heterodyne detection. The local oscillator (the laser at the detection end) should have exactly the same frequency (wavelength) as the transmitting laser diode (oscillator). Such exact frequency matching is very difficult in the homodyne situation because phase matching is required.

In many current schemes, direct detection is used. FIG. 1B illustrates direct detection. The transmitting laser is keyed on and off (it is not phase modulated); the receiving detector is simply an intensity detector—it generates a signal directly in response to the intensity of the received signal.

Direct detection implementation is far simpler than other detection schemes, and therefore, quite popular. Coherent detection is attractive in that it has 10-20 dB greater sensitivity, but it is more costly and more complex to introduce. As optical communication systems become more complex, greater sensitivities are required to move to higher data rates or may for other reasons become more popular.

A great advantage of coherent type detection is that it typically uses phase modulation rather than on-off keying. Phase modulating the transmission laser results in a signal having a constant intensity, as phase is varied and as intensity remains constant. This results in a system, which is much less susceptible to interference effects such as cross phase modulation. This decreased susceptibility to interference adds to the attractiveness of phase detection.

The inventive approach as taught U.S. application Ser. No. 02/0360 (generating a set of wavelengths as an integrated entity) is free from the need to match each individual wavelength of the local oscillator to the wavelength of the transmitting oscillator, the local laser to the transmitting laser. Rather, it is only necessary to match the wavelength set at the receive side to the wavelength set from the transmitting side. Matching the set is inherently an easier task because if one wavelength is modified, the entire set is moved in precisely the same manner—the wavelengths track each other.

Another advantage, of the multiple wavelength generation approach is that additional wavelengths can be readily generated and sent down the fiber from the transmit side to act as pilot or reference signals. The detection side can use such reference signals to “sync up” (or “lock up” or match) wavelengths. This ability to generate and use reference signals to lock the second multiple wavelength generator arises from the fact that in multiple wavelength set generation there is a coherent relationship between the wavelengths.

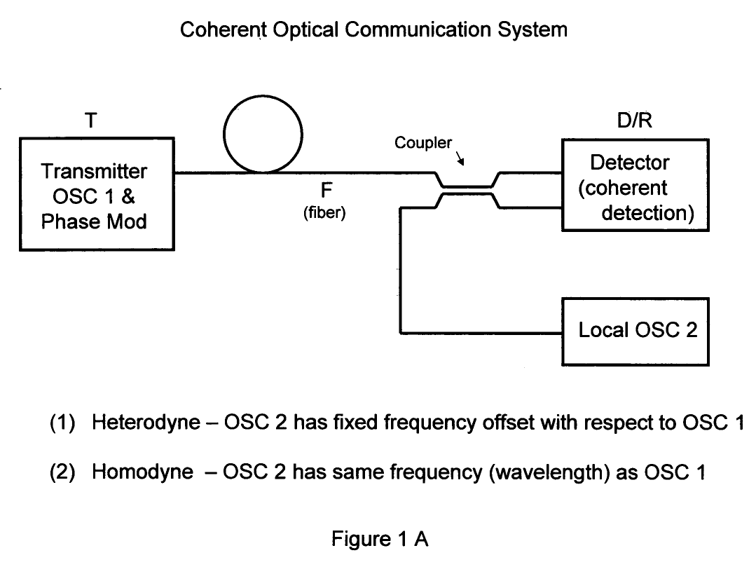

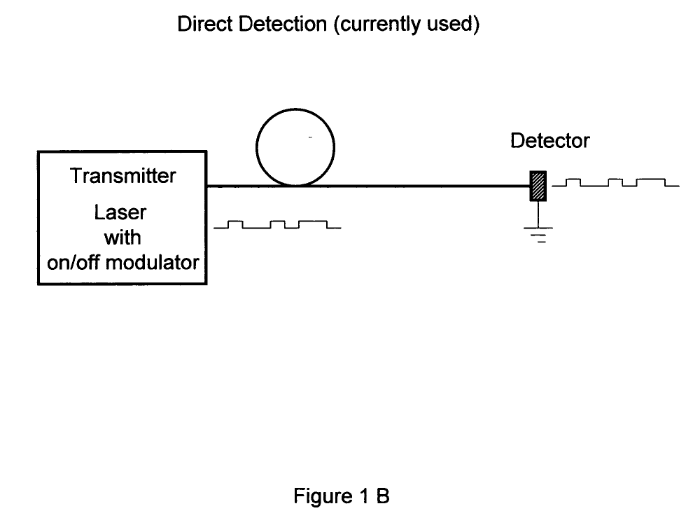

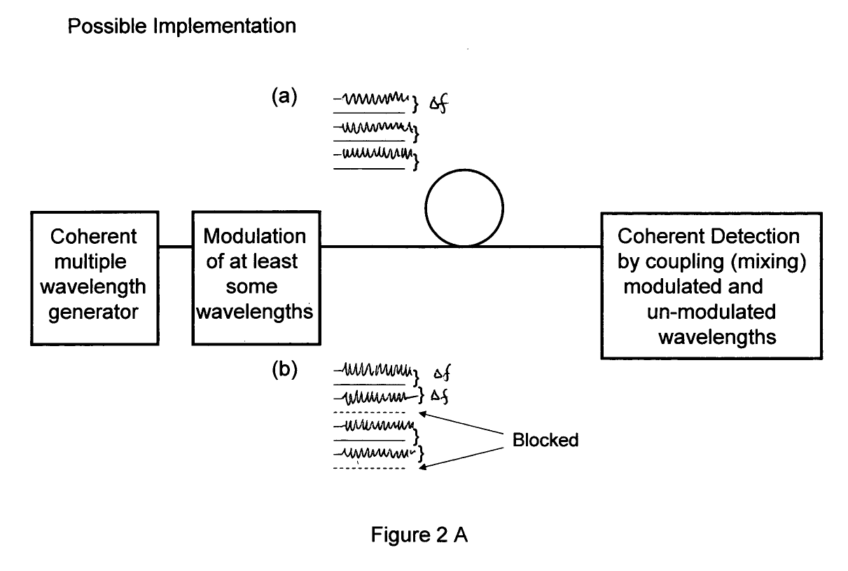

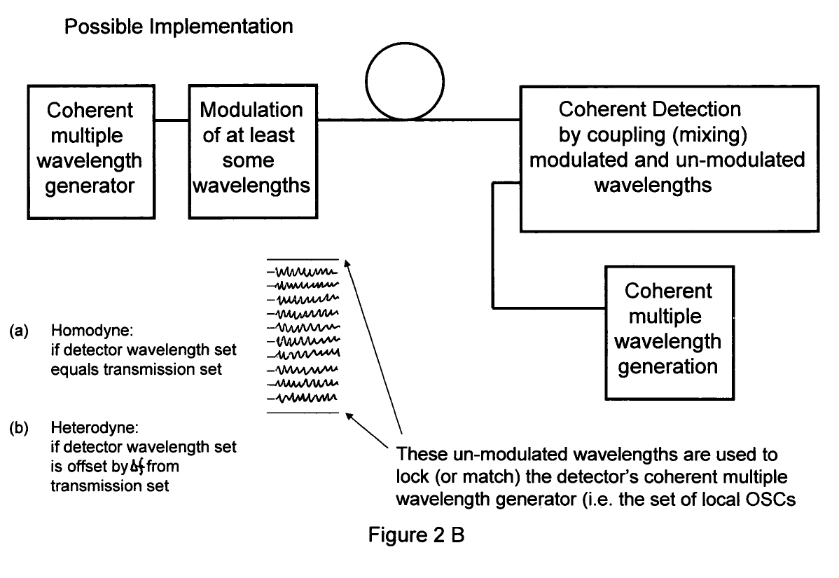

Preferred implementations of the invention are depicted in FIGS. 2A(a) and (b) and 2B(a) and (b), inclusive. Referring to the FIG. 2A, the left block represents a coherent multiple wavelength generator system, the second block represents a modulation system that separates the wavelengths and modulates at least some of the wavelengths so that data can be sent with them. Other wavelengths may sent un-modulated as references to be used at the detection end. At the other end (the detection end), coherent detection is accomplished by coupling (mixing) one of the unmodulated wavelengths with one of the modulated wavelengths; and there are at least two possible variations. Variations of FIG. 2A(a) and (b):

FIG. 2A(a) For every modulated wavelength there is an adjacent unmodulated wavelength; these two get coupled together, become paired, and are effectively mixed in the detector—the optical to electronic detector system is the mixing mechanism. In this embodiment, the resultant signal out of the detector will be a heterodyne signal which has its center frequency determined by the frequency difference between the two wavelengths—the reference wavelength and the modulated wavelength.

FIG. 2A(b) One reference wavelength is used for both of the modulated wavelengths—one on either side of that reference wavelength. This has some advantages. It is possible to use a simpler wavelength combination separator mechanisms. It also creates a guard band between the set of three wavelengths, in the blocked (unsent) signal that occurs every fourth (1 of 4) times.

In each of these cases associated with implementation FIG. 2A inclusive, there is no local oscillator at the detection end. This serves to simplify and it also has the advantage that the reference signals go through the same fiber therefore substantially the same interference-substantially the same noise, etc. as the modulated signals; therefore, these cases present an opportunity for common mode rejection of noise.

Referring now to FIG. 2B, FIG. 2B illustrates the inventive implementation having local oscillators (or a coherent multiple wavelength generator) at the detection end. The task is to match, at the detection end, a set of locally generated wavelengths (set of coherent wavelengths from the coherent multiple wavelength generator) to the set of wavelengths generated at the transmission end. To accomplish this, some unmodulated wavelengths are sent along with the modulated wavelengths. One implementation is to send unmodulated wavelengths at the outlying portions of the wavelength set—i.e. the high and low wavelength values.

These un-modulated wavelengths (or pilot tones) may then be used at the detection end to help lock the set of locally generated wavelengths to the set or wavelengths from the transmission side. If the set of locally generated wavelengths are matched identically to the set of transmission generated wavelengths, then the circumstance is that of homodyne detection. This is a phase sensitive technique and consequently very difficult—any phase noise would manifest itself as signal error.

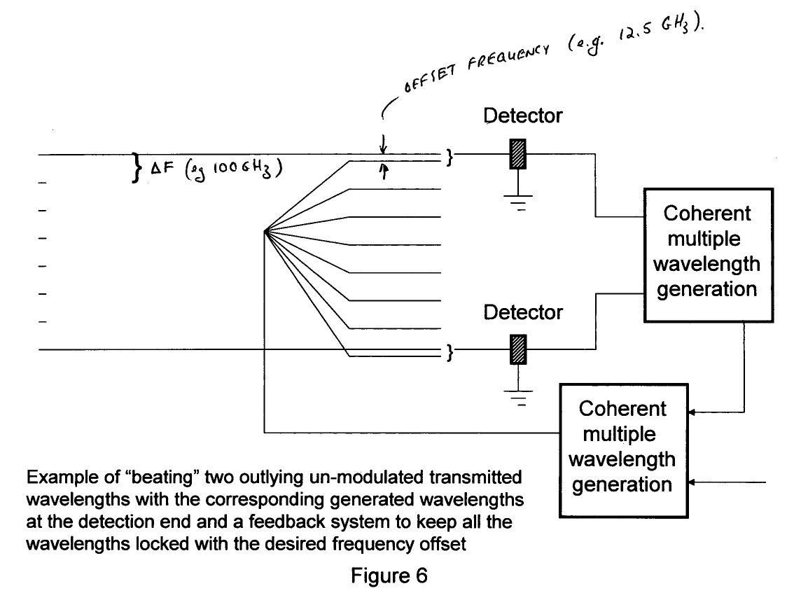

To provide heterodyne detection, the detector set must be offset by a frequency (delta F) from the transmission set. This may also be implemented by using the reference signals that are sent down to lock or match the two sets. Typically, one would generate a signal wavelengths also corresponding to the two reference wavelengths that are sent down, but with a frequency offset. By beating those two corresponding reference wavelengths together (see FIG. 6), a signal is generated that can be locked to the desired offset. The whole set of wavelengths will automatically shift by that offset because they are generated as a set.

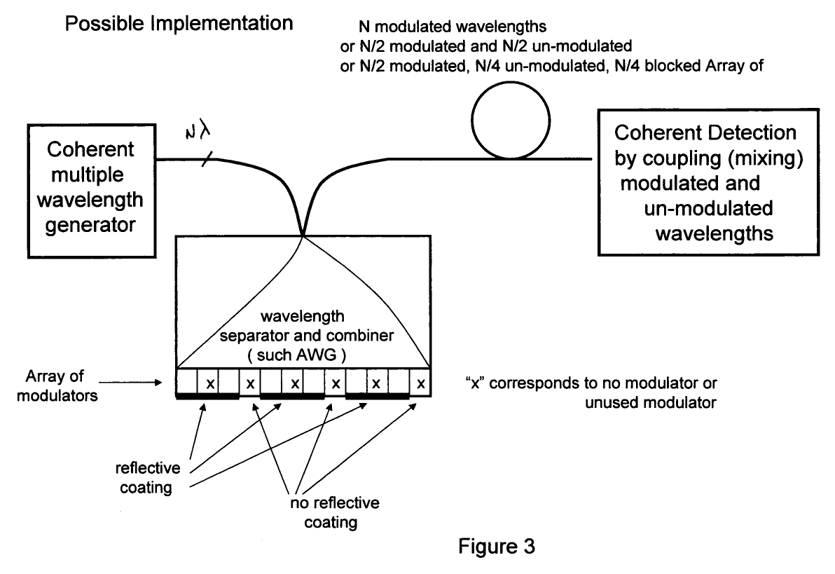

FIG. 3 further depicts the preferred embodiment. The reference wavelengths between modulated wavelengths are shown. The first left hand block depicts a coherent multiple wavelength generator. The output is single fiber with N wavelengths (none are modulated at this stage). Such N wavelengths need to go to the unit which has a wavelength separator (triangle-like shape depicted in FIG. 3). Ideally, this would be an arrayed wave-guide (AWG). The output of the arrayed waveguide (AWG) would be a set of N waveguides.

Each of the waveguides now would have one of the wavelengths emerging from that section, These wavelengths would be aligned with an array of modulators (seen in FIG. 3) with a reflective coating (seen in FIG. 3). Each individual wavelength, as it emerges, would go into one of the modulators in the array, which give the opportunity to modulate that wavelength. The reflective coating then would send it back through the modulator, back through the AWG, (the AWG is both a wavelength separator and a wavelength combiner) so that at the other end, all of the wavelengths come back together and there's a simple mechanism for making them come out on a second output fiber. At this stage there are N modulated lambdas or wavelengths.

In some inventive embodiments, it may be desirable not to modulate all wavelengths. Alternatively, there may be a purely reflective coating with no modulator (or an unused modulator). By this means, a reference signal could be placed in between wavelengths; or, as depicted in FIG. 2A(b), there would not be a reflective portion on every fourth wavelength and hence the wavelength would not be transmitted (i.e. would be blocked).

In this way, numerous variations can be implemented in a highly integrated manner using an AWG (an integrated wavelengths separator/combiner) and an array of modulators with reflective coating. On the detection/receiver side, the modulated signals must be combined with one of the reference signals to get a heterodyne detected signal which would then be electronically processed to extract the modulated data.

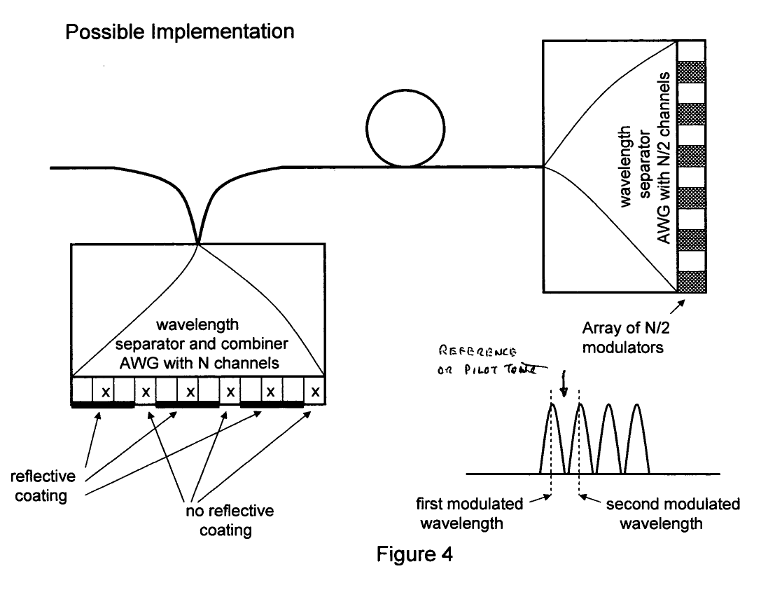

Depicted in FIG. 4 is a detection system for implementation FIG. 2A(b). As shown in the FIG. 4, the system provides that on the transmit side, every second wavelength is modulated and in between two modulated wavelengths, there is an unmodulated reference signal, while every second un-modulated reference wavelength is blocked (un-transmitted). A single, unmodulated wavelength serves as the reference signal for the modulated wavelengths on either side of it. This enables, on the detection side, use of an AWG (array wave guide) with only half the number of channels. The AWG is lined up so it receives the modulated wavelengths centered on those, and the un-modulated wavelengths that are sent between them will effectively spill over into both the modulated channels and thereby act a reference signal for both of them.

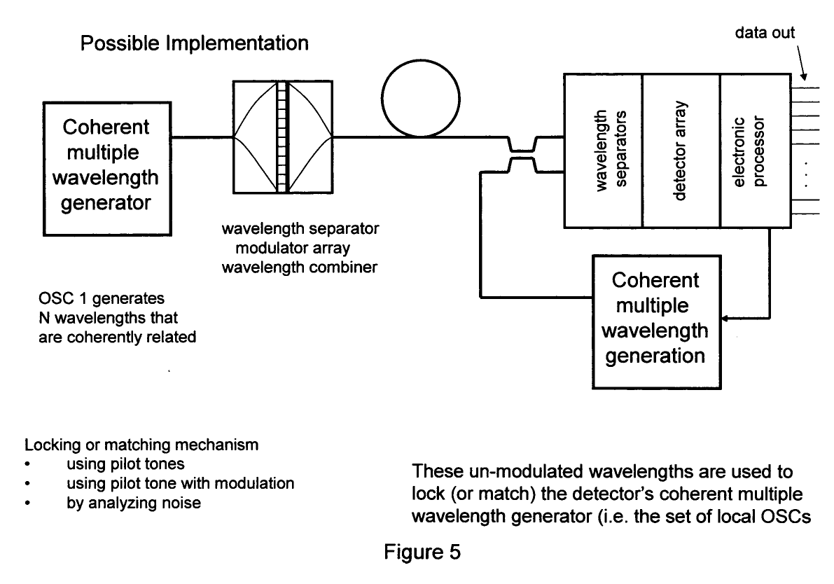

FIG. 5 depicts a complete system where the coherent multiple wavelength generator on the receive side is locked to the coherent multiple wavelength generator on the transmit side by use of un-modulated pilot tones. Alternatively, the pilot tones could be modulated with a predetermined pattern, or all wavelengths could be modulated and the locking information derived from noise analysis of the detected signals.

FIG. 6 depicts a possible heterodyne configuration with typical wavelength separation values and offset values.

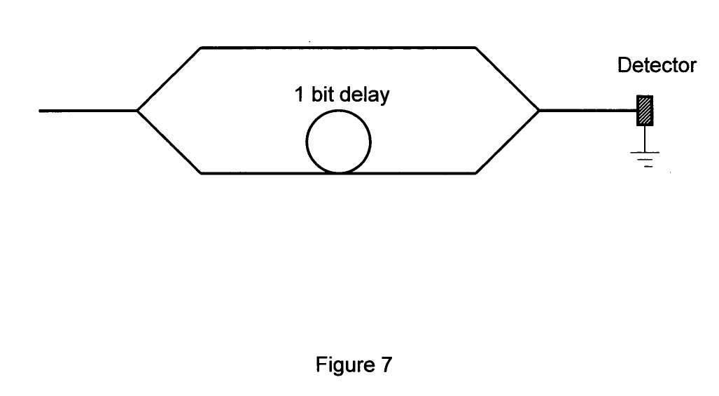

Differential Phase Shift Keying (DPSK) is a form of coherent detection that involves self referencing. It does not require an additional, separate reference signal. The basic idea behind the approach is the information is encoded in the relative phase of successive bits. DPSK involves a slightly different encoding technique, requiring a one-bit delay as depicted in FIG. 7, and some decoding processing to recover the original signal. DPSK has the advantage, because it is phase modulation, of being a constant intensity modulation scheme. Because it is self referencing, it does not require an independent reference signal and thereby avoids all of the problems associated with an independent reference signal.

DPSK and the invention taught herein provide an enhanced self referencing phase modulation system. The enhancement to this form of detection is attributable to the inclusion of generating a set of coherent wavelengths rather than wavelengths from individual laser diodes; and such a set of coherent wavelengths having a lower phase noise characteristic. This lower phase noise means that the set of coherent wavelengths is less noisy than the individual wavelengths generated from laser diodes. The lower phase noise of the wavelength set enhances the performance of DPSK and other self referential coherent detection systems.

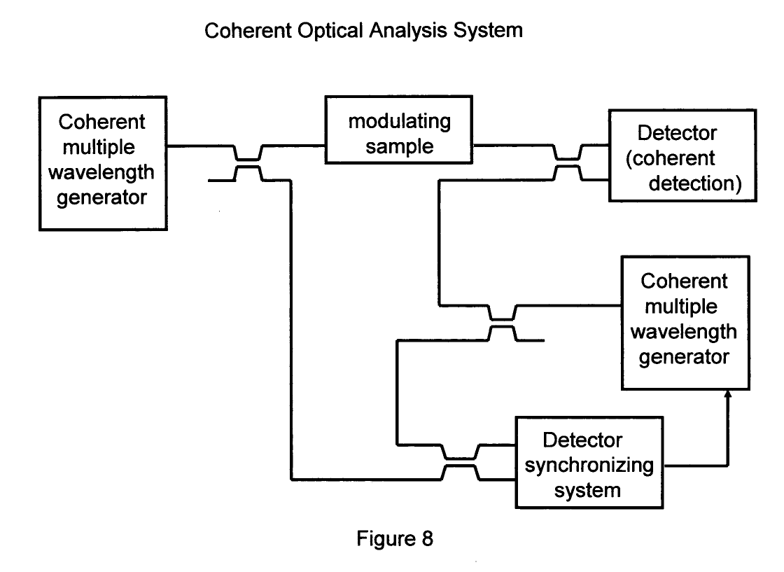

In another embodiment, a coherent optical system that generates multiple wavelengths as a set can be used as an analysis system. This is illustrated in FIG. 8 wherein a portion of some or all of the wavelengths generated by the transmitter is available for combining with the local oscillator multiple wavelength generator to match the local oscillator set to the transmitter set, including any desired offset. In this case, modulation of the wavelengths is accomplished by interaction with the sample to be analyzed. The modulated wavelengths, captured either in transmission or reflection mode, are combined with the local oscillator wavelengths and the modulated signals are detected and analyzed.

It is understood that the above description of the invention is illustrative and not restrictive, and many of the features have equivalents and these are intended in the inventive teaching hereinabove. The invention can include free space or wave guide systems implementation as well as fiber based systems. Other implementations will be apparent to persons skilled in the art. The scope of this invention is intended to include the description, the appended claims, the drawings, and such full scope of equivalents as each may be entitled.

1. An optical detection system consisting of at least one multiple wavelength generator operable to provide a mechanism to derive information from the relationship between the pairs of wavelengths in the set and between corresponding wavelengths in two or more sets.
